(19) United States
(12) Patent Application Publication
(10) Pub. No.: US 2008/0228598 A1
(43) Pub. Date: Sep. 18, 2008

(54) Providing marketplace functionality in a business directory and/or social-network site

(76) Inventors: Andy Leff, Philadelphia, PA (US); Ron Lefl, Gladwyne, PA (US)

Correspondence Address: MONTGOMERY, MCCRACKEN, WALKER & RHOADS, LLP, 123 SOUTH BROAD STREET, AVENUE OF THE ARTS, PHILADELPHIA, PA, 19109, US

(21) Appl. No.: 12/075,106

(22) Filed: Mar. 6, 2008

Related U.S. Application Data
(60) Provisional application No. 60/905,562, filed on Mar. 6, 2007.

(51) Int. Cl. H04N 5/14

(52) U.S. Cl. 705/27

(57) ABSTRACT

A business directory and/or social-network site with business-to-business, real-time e-commerce capability as well as business-to-consumers, real-time e-commerce capability. Other aspects include systems/methods for targeting users of the business directory and/or social-network site with advertising, which relates contextually to the interests and behavior of a user. Such advertisements are presented to the user on the user's private bulletin board.

### CROSS REFERENCE TO RELATED APPLICATIONS

The present patent application claims benefit of U.S. Provisional Application Ser. No. 60/905,562 filed on 6 Mar. 2007.

### TECHNICAL FIELD

The present invention relates generally to business directories, and social networks. In particular, the present invention relates to a system and method for providing marketplace functionality in a social-service network and/or business directory.

### BACKGROUND

Just over ten years ago the first social-network website was launched. Though this first site closed after only three years, social-network sites (“SNSs”) are a current day emergent phenomena that number in the hundreds. Broadly defined, SNSs are web-based services that enable a registered “user”: (a) to create a public profile within a bounded system; (b) to identify others with whom the registered “user” shares a connection, and (c) to view and traverse the registered user's list of connections and those lists of connections made by others within the system.

One unique feature of SNSs is that they enable their registered “users” to present themselves in a public forum by making their profiles accessible to others on personal web-pages that are created for each registered “user” within the system. Such web exposure can and does result in connections that would not otherwise be made between registered users and between visitors to a registered user's web-page. In addition to a user's profile and list of connections, SNSs also allow registered users, and visitors to a registered-user's web-page to post comments to the user's web-page that are viewable by at least the registered user if not others.

As of February 2008, a Google® search revealed over one hundred active SNSs. Of these active SNSs, some list as few as 11,600 registered users, nearly one half list over 1,000,000, while one SNS lists as many as 300,000,000 registered users. As one might imagine, the purpose or “focus” of these SNSs varies greatly. For example, active SNSs include such stated focuses as: books, music, volunteering, recreational sports, travel, social action and several simply claim to be of a general focus.

A feature common to most, if not all SNSs, is that their registered users appear to be individuals. Even those few SNSs that list business as their focus are for the limited purpose of allowing their registered users to maintain lists of contact details for the individuals they know and trust in business.

Turning to another area of the web that is popular with consumers and businesses alike, are “business directories,” such as Yellow Pages, which have long been provided as printed publications and, more recently, as online directories. These online business directories are accessible via the Internet or other computer networks. Such business directories, however, only provide consumers with limited information about its listed businesses, such as basic contact information. The business listings are often grouped or classified according to the relevant category or categories of products or services offered by the business. Within the groupings and classifications, the listings may be alphabetically or otherwise ordered.

Online business directories, as mentioned above, typically include a profile for each listed business that only includes basic information, such as a website address, telephone number, and a street address. Otherwise, business directories, mainly serve, purely, as a venue for cataloging sources for products/services within limited locales, and other information related to products/services of the business, such as consumer ratings, etc.

Online business directories, and SNSs, may provide different avenues for learning about a business, networking, and even provide information or links where it is possible to purchase businesses' products or services. But the user must leave or be directed away from the social-network or the business-directory site when it is desirable to purchase a product or service.

Further, tracking a user's habits in a business directory or a social network is often complicated when a user leaves the domain of the business directory or SNS site to perform other activities, such as purchasing a product or service. When the user leaves a website to perform these other activities, it is not possible to fully monitor their preferences or activities. Consequently, advertisers may not effectively target the user based on context-based advertising, because much of the user's habits are across disparate websites.

Further, in a business-directory or social-network setting, when advertisements are sent to a user's e-mail box, they are typically filtered out as spam, or ignored. Other forms of advertising, such as pop-up ads, or search-result-based advertising—for example that appears on the right-hand side of a Google® search as “Sponsored Advertisement”—is often ignored by the user as simply webpage spam.

Still further, many online business directories only track a user based on cookies, and not based on membership to the directory, making it difficult to truly identify and target the same user over time.

### SUMMARY

To address the above-discussed deficiencies of the prior art, this invention provides, in one aspect, a business directory in which business members can display and sell, their respective products or services directly to users in real-time from the business directory. Similarly, in another aspect of the invention, members of an online social-network site, such as business members, can also display and sell, their respective products or services directly to users in real-time from the social-network site. As part of the social-network site members and intended registered users may include businesses rather than individuals. Further, a business-directory site and a social-network site may also be integrated, to offer directory and social networking forums in a single site.

Thus, this invention introduces the broad concept of a business directory and/or social-network site with business-to-business real-time e-commerce capability as well as business-to-consumers real-time e-commerce capability. Such a site provides a dynamic web-based environment for direct interaction between businesses, and between businesses and individual consumers. The site also provides an efficient online marketplace within which both businesses and individual consumers may purchase products or services, in real-time, without having to exit their social networks and/or business directories.

In another aspect of the invention, a computer-implemented method automatically tracks movement or behavior of users of the business directory and/or social-network site, and records data associated with the behavior in a database. The method associates the behavior, where applicable, with a product or service category. It then determines whether the movement or behavior associated exceeds a predetermined threshold, which is an indication that movement or behavior is repetitive. If the movement or behavior is determined to be repetitive, an advertisement is sent to the member. Typically, the advertisement includes content related to the product or service category associated with movement/behavior. In one aspect of the invention, the advertisement is displayed on a private bulletin board, viewable by the member.

So, this invention also introduces the broad concept of a computer-implemented method for targeting users of a business directory and/or social-network site with advertising, which relates contextually to the interests and behavior of a user observed on the site. As the user does not have to leave the site to perform e-commerce functionality or other tasks, it is possible to maintain observation of the user, and provide a more complete history of the true interests/behavior of users of the site. Further, as users may be members of the sites, it is also possible to more readily confirm their identity when they login into a site, and hence identify their behavior over time, with certainty, that the same member is being tracked.

Still further, in another aspect of the invention, the method displays advertisements on a private bulletin board associated with the user, as opposed to an email account, where filters may block the advertisement from reaching the recipient. The bulletin board relieves the user of the burden of spam, as advertisers may have to pay for the privilege of submitting messages on the bulletin board of a user. Different coloring or other indicia may distinguish advertisements, from other messages on the bulletin board.

The foregoing summary provides an exemplary overview of some aspects of the invention. It is not intended to be extensive, or absolutely require any key/critical elements of the invention.

### BRIEF DESCRIPTION OF THE DRAWINGS

The detailed description is explained with reference to the accompanying figures. In the figures, the left-most digit(s) of a reference number identifies the figure in which the reference number first appears.

FIG. 1 shows a network environment within which the present invention can be either fully or partially implemented.

FIG. 2 illustrates a webpage for displaying a plurality of business members on an online-business directory and/or social-network site.

FIG. 3 shows an exemplary webpage with content appurtenant to a business member.

FIG. 4 shows an exemplary webpage with products from different members displayed thereon.

FIG. 5 illustrates an exemplary design-template page for uploading product/service pictures, text, and other information.

FIG. 6 illustrates a method for listing services/content for immediate sale to a consumer on an online-business directory and/or social-network site.

FIG. 7 shows an exemplary bulletin board.

FIG. 8 shows a system for monitoring and recording user activity on an online-business directory and/or social-network site.

FIG. 9 illustrates an exemplary method for monitoring a member's behavior on an online-business directory and/or social-network site, for purposes of sending a targeted advertisement.

FIG. 10 illustrates an exemplary computing device.

### DETAILED DESCRIPTION

Reference herein to “one embodiment”, “an embodiment”, or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used herein, a “business directory” is an online-website publication including listings for a plurality of businesses, commercial entities, and/or public/private organizations. Each listing may include, for example, the name, address, and contact information of an entity on the site. The listings may be alphabetically or otherwise organized. For example, entities may be classified according to a relevant category or categories of products or services offered by the respective entity. It is noted that reference to the term “business” may include any public/private organizations, but does not generally refer to a non-business entity such as a person.

Heretofore, business directories traditionally concentrated on listing information about the business itself. To purchase a product or service from a business, business directories, presently, include a link in each listing which, when “clicked” (i.e., is selected) by a user, transfers the user to a webpage hosted by the business, such as a homepage for the business, where the user may purchase a product/service of the business, but from a website hosted by the business, which is distinct from the business directory.

As shall be described herein, this invention not only facilitates the ability for business directories to list information about the business itself as traditional directories. But it also permits the businesses, themselves, to customize their own listings on the business directory to include products/services available for direct sale to users of the business directory website, itself. So, a user does not have to leave the business directory website to purchase products/services of a business listed in the directory.

As used herein, a “social-network site” (SNS) is an online, web-based site that enables a registered user (e.g., a member): (a) to create a public profile within a bounded site; (b) to identify others with whom the registered member shares a connection, and (c) to view and traverse the registered member's list of connections and those lists of connections made by others within the system.

Presently, most SNSs are used to connect individuals in a social-interaction context. That is, their registered users of SNSs appear as individuals. Even those few SNSs that list business as their focus are generally limited to allowing their registered users to maintain lists of contact details for the individuals they know and trust in business.

Also, like business directories, SNSs do not permit real-time purchasing of products/services from the SNSs. That is, to purchase a product or service from a business (such as an advertisement or discussion blog), a member of an SNS must leave the SNS by clicking a link that transfers the member to a webpage hosted by the business (or entity), such as a homepage for the business, where the user may then purchase a product/service of the business. But, again from a website hosted by the business, which is distinct from the SNS.

As shall be described, this invention facilitates the ability for a business member of an SNS to customize their own listings on the SNS to include products/services available for direct sale to members of the SNS. So, a member does not have to leave the SNS to purchase products/services of a business in the SNS.

As used herein, an “online-business directory and/or social-network site” means an independent website that includes a collection of web pages, images, videos, content or other digital assets all directed to a business directory, a social, or some hybrid combination of two; and all hosted on one or several Web server(s), usually accessible to users or members of the site via the internet, or some other network.

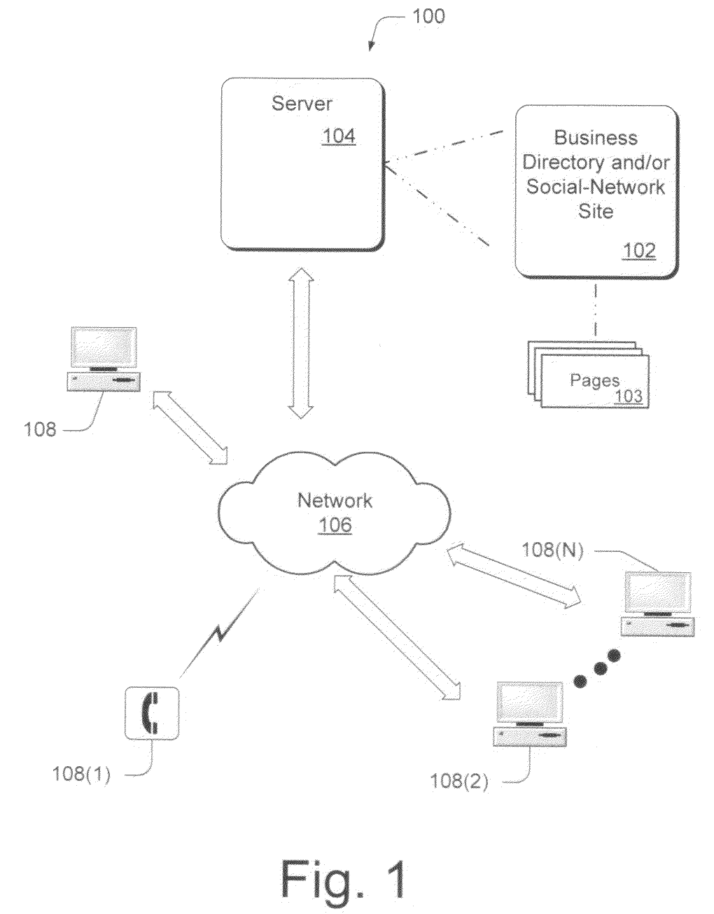

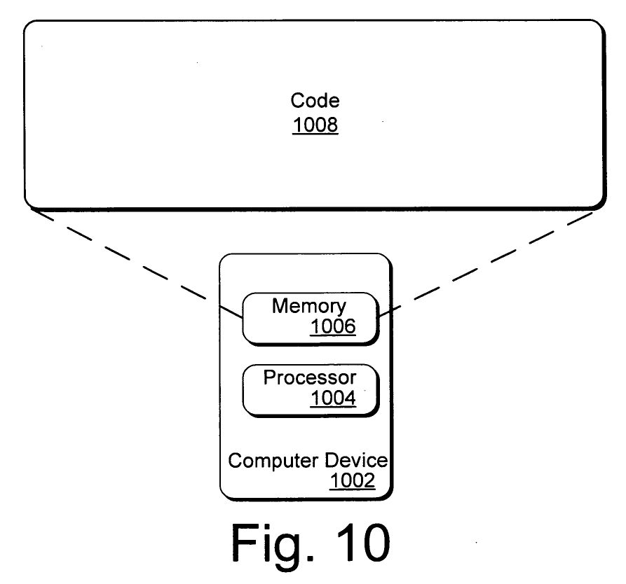

For example, FIG. 1 shows a network environment 100 within which the present invention can be either fully or partially implemented. In one possible embodiment, network environment 100 includes an online-business directory and/or social-network site 102 hosted by at least one server 104. One or more users or members of site 102 may connect to it via a network 106 (such as the Internet) and the user/member's client-side computers 108(1), 108(2), . . . , 108(N). As appreciated by those skilled in the art, server 104 and client-side computers 108 may be implemented as any suitable computer processing system, such as the representative system (computing device) shown in FIG. 10 (described below).

Also, as appreciated by those skilled in the art, server 104 and client-side computers 108 may utilize any suitable combination of communication protocols and computer-program applications (code) to communicate with each other, such as, but not necessarily limited to Hypertext Transfer Protocol (HTTP), Transmission Control Protocol/Internet Protocol (TCP/IP), Wireless Application Protocol (WAP), and a myriad of other protocols/applications.

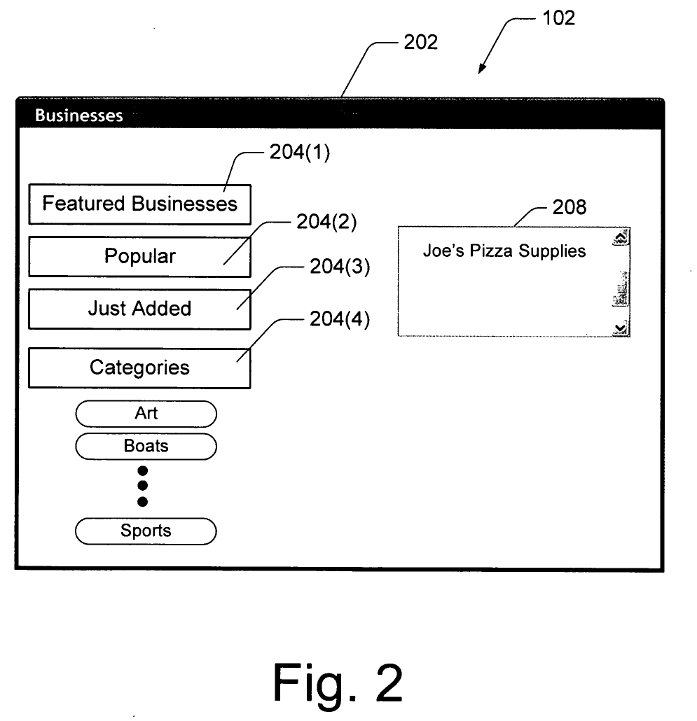

Site 102 includes a collection of related data, pages (e.g. 103), files, etc. relating to business directories and/or social networking. Server 104 transmits the collection of data from site 102 to a user/member via their client-side computer 108 (and via network 106), based upon requests made by the client-side computer 108. For example, a user may request a web page (see FIG. 2), that is displayed on a client-side computer 108. Typically, site 102 includes a “home page,” which usually serves as the first and main page to any website, as is well known to those skilled in the art.

FIG. 2 illustrates a webpage 202 for displaying a plurality of business members 204(1), 204(2), . . . , 204(N) on a online-business directory and/or social-network site 102. Webpage 202 is rendered on a client-side computer 108. As depicted in FIG. 2, webpage 202 includes section icons 206(1), 206(2), 206(3), 206(4) 206(5) that allow the user to view information about a business in a window 208 of page 202. For example, clicking on featured business icon 206(1) displays those businesses that have a “highlighted” status by site 102. In this illustration, window 208 includes business members 204. While not shown, selecting popular icon 206(2) populates window 208 with business that are most frequently visited on site 102. Clicking “just added” icon 206(3) displays businesses that are new to site 102. Clicking categories icon 206(4) displays businesses appurtenant to a category of products/services offered by a respective business.

As appreciated by those skilled in the art, other suitable content may be included on page 202, or on other display screens/pages. Accordingly, some or all of the icons may be displayed in different formats, in different pages, in different order, in different colors, in different highlights, in different font, with different verbiage, etc.; and page 202 is only illustrated as one exemplary implementation.

In one embodiment, a “business member” includes a business entity that pays or registers to list their business on site 102. As appreciated by those skilled in the art, after having the benefit of this disclosure, however, a “business member” may include businesses that are not necessarily affiliated with site 102, and therefore, do not pay or register to be a part of site 102.

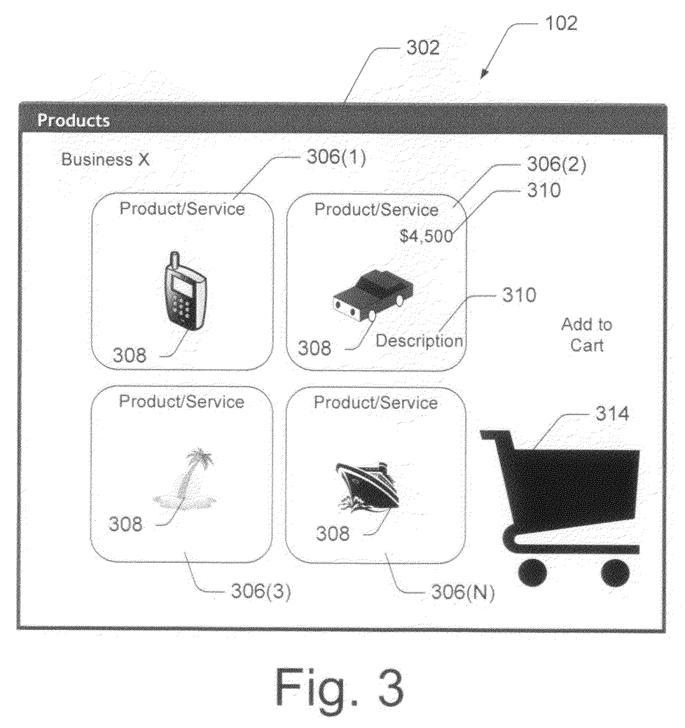

Supposing a user or member of site 102 selects a featured business in FIG. 2, such as business member 204(1), then a new page 302 (FIG. 3) may be displayed on a user's client-side computer 108. For example, FIG. 3 shows an exemplary page 302 with content appurtenant to business member 204(1). Page 302 remains within site 102, and includes icons or tabs 304, which permit the user to navigate to other areas within site 102.

As depicted in FIG. 3, page 302 also includes e-commerce capability. That is, page 302 includes one or more products and/or services in windows 306(1), 306(2), . . . , 306(N), which are offered for sale by business member 204(1). Each window 306 may include a picture of the product/service for sale 308, pricing information 310, a description of the product/service 312, and other suitable information as would be appreciated by those skilled in the art, after having the benefit of this disclosure. Additionally, a user may click on a window and be presented with further information such as ratings, recommendations, detailed-product information, customer reviews, and so forth.

Page 302 may include a shopping-cart icon 314 for a user to select a quantity of a product or service offered by the business member. Icon 314 allows a user to take steps to purchase the product/service through any suitable checkout procedure, as would readily be appreciated by those skilled in the art.

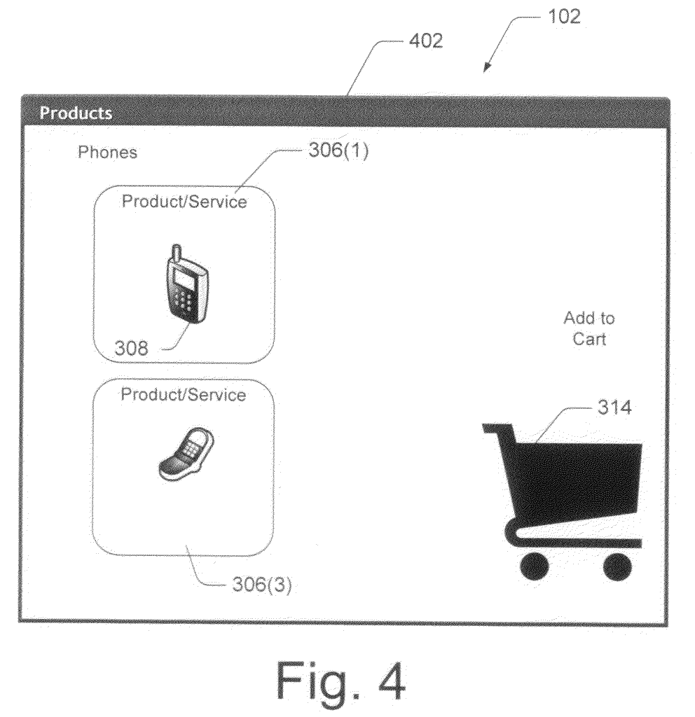

It is also possible for products/services within site 102 to be displayed according to a classification associated with a product or service, such as depicted in the exemplary embodiment of FIG. 4. For example, if a user selected category-icon 206(4) (FIG. 2), the user may be presented with a page 402 of windows 306 including products/services from a plurality of heterogeneous business entities. Further classification and categorization schemes may be employed including delineating a region where the product or service is available, such as relative to a user's location (if known). Page 402 may also include a shopping cart 314. Again, as appreciated by those skilled in the art, other suitable textual or graphical information may be used to display a group of products/services in a page 402. Pages 302 and 402 may serve as an e-commerce component to a business-directory site, social-service-network site, or a combination thereof.

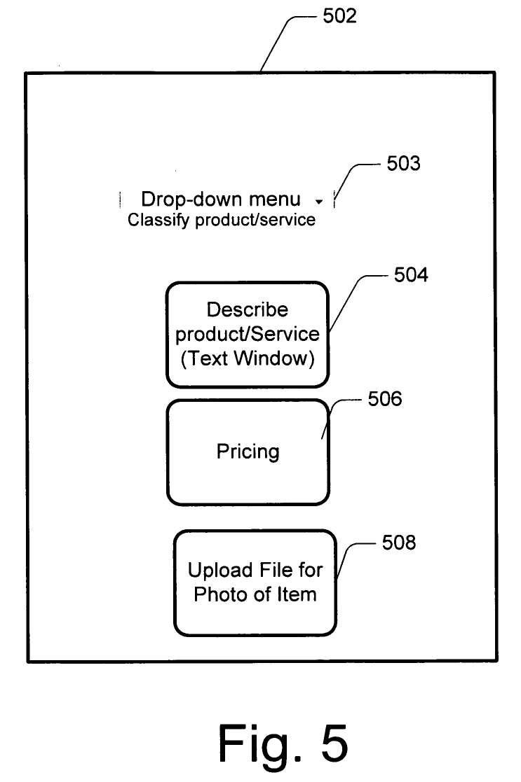

A business member may list products and services for sale on site 102. That is, a business member may post products and/or services for sale on site 102. To simplify the ability for business members to use a myriad of easy-to-use design templates to input products/services, and customize the business member's marketing information. For example, FIG. 5 illustrates an exemplary design-template page 502 for uploading product/service pictures, text, and other information. In one embodiment, design template page 502 includes a drop-down menu 503 to classify the product or service, a text window for uploading text 504, a pricing window 506 for uploading pricing information, and a picture control 508 for uploading a picture or video of the product/service. As appreciated by those skilled in the art, various other suitable web-based tools, applications, and windows may be used by a business member to upload text files, products, services, and even inventory information. Thus, a business member may customize their own listings on the SNS to include product/services available for direct sale to members of the SNS.

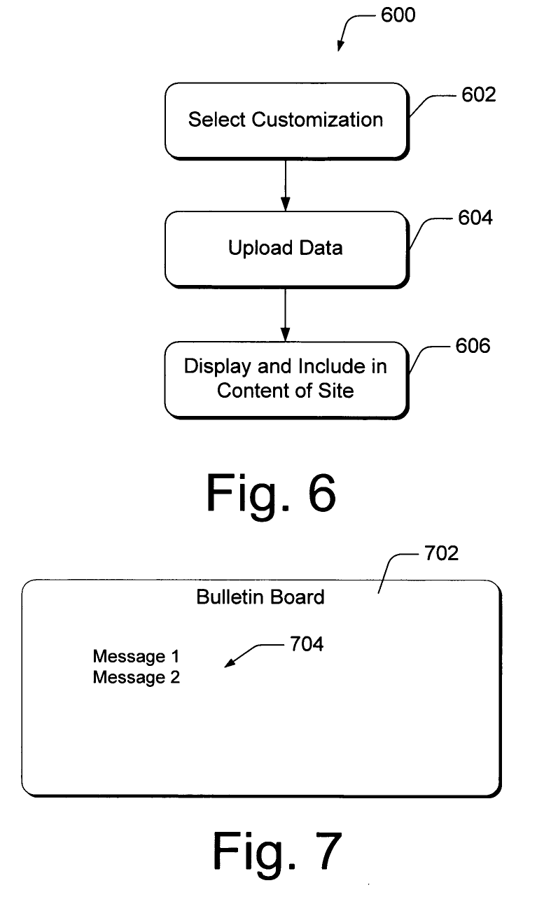

FIG. 6 illustrates a method 600 for listing services/content for immediate sale to a consumer on site 102. Method 600 includes blocks 602, 604 and 606 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof. Additionally, although each module in FIG. 6 is shown as a single block, it is understood that when actually implemented in the form of computer-executable instructions, logic, firmware, and/or hardware, that the functionality described with reference to it may not exist as a separate identifiable block.

In block 602, a business member (a user) enters a web customization section of site 102, such as design-template page 502 (FIG. 5). In block 604, the business member uploads a product or service into the site. During this operation, the products/service may be associated with one or more categories or subcategories of products/services. In block 606, upon conclusion of the uploading process, the products/services are available for display as part of the product or service content-area of the business member and/or aggregated together in a categorical-market-area section of site 102.

Visitors of site 102 may access products and/or services by keyword searches for a specific product/service. A visitor may purchase the product/service by selecting an item listed, such as in a window 306 (FIG. 3), adding to a cart 314 (FIG. 3), and “checking-out” of site 102 using any suitable payment option acceptable by site 102, such as a credit card or an e-commerce feature such as Paypal® services.

Another aspect of site 102 includes the ability of visitors (members/users) to receive messages, or postings via a virtual “bulletin board.” This bulletin board may be private, and only accessible by a member of site 102, semi-private, or publicly viewable. In one exemplary embodiment, the bulletin board is private, and is only available to registered users of exemplary site 102. The bulletin board is intended to promote intra-site communication.

FIG. 7 shows an exemplary bulletin board 702. In one embodiment, bulletin board 702 includes a section 704 for receiving messages. Some messages may include a targeted advertisement. An advertisement may be sent to a user based on known attributes associated with the user, such as age, sex, location, marital status, health, religion, political affiliation, credit score, and so forth. The advertisements may be displayed in any combination of suitable text or graphical representations, including pictures, sound, or even video content. Advertisements may be distinguished from other messages on the basis, such as being displayed in blue, to denote an advertisement. Where as other message may appear in black.

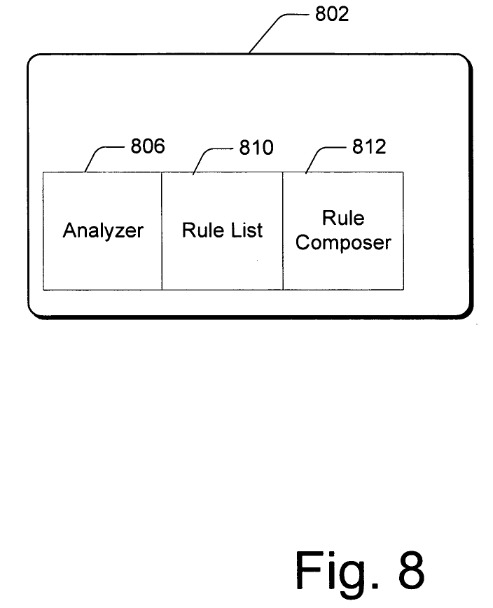

FIG. 8 shows a system 800 for monitoring and recording user activity on site 102. To improve targeting of advertisements, a monitoring application (code) 802 shown in FIG. 8, running on server 104, monitors each user's activity on site 102. As depicted in FIG. 8, monitoring application 802 records a user's activity when logged-in to site 102 (via their computer device) and records data reflecting each user's activities, respectively, in a database 804. In one exemplary implementation, activity recorded may include: a list and quantity of each keyword used to perform a search, verbiage used in a chat session, a list of pages within the site visited, types of products/services researched, an identification associated with the member, and other descriptive data, such as the date/time, and duration of these activities.

An analyzer module 806 scans a rule list 810 to determine if an activity (such as movement or behavior within site 102) performed by the user matches a threshold rule, set by an advertiser or administrator of site 102. If it does match threshold rule, analyzer module 806 can transmit a message alerting the administrator, or advertiser of the activity. A rule composer module 812 enables administrators of site 102 to configure and deploy rules for alerts or monitoring. Such membership movements and behaviors may be sold to advertisers, or business members of site 102.

For example, a threshold rule may involve notifying an advertiser when a particular member searches for “pizza” more than twice in a period of a week. Based on this information, the advertiser may elect to automatically send an advertisement (or have the system of site 102) send a predefined advertisement to the particular member via their bulletin board 702 (FIG. 7) with an advertisement about pizza.

So, this invention targets users of a business directory and/or social-network site with advertising, which relates contextually to the interests and behavior of a user observed on the site. As the user does not have to leave the site to perform e-commerce functionality or other tasks, it is possible to maintain observation of the user, and provide a more complete history of the true interests/behavior of the user of the site. Further, as users may be members of the sites, it is also possible to more readily confirm their identity when they log onto a site, and hence identify their behavior over time, with certainty, that the same member is being tracked.

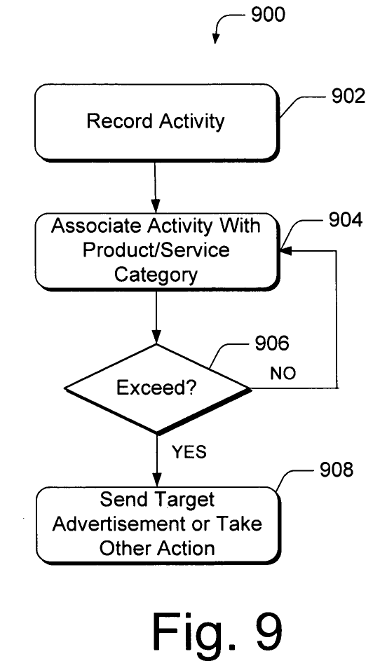

FIG. 9 illustrates an exemplary method 900 for monitoring a member's behavior on a site 102 for purposes of sending a targeted advertisement. Method 900 includes blocks 902, 904, 906, and 908 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof. Additionally, although each module in FIG. 9 is shown as a single block, it is understood that when actually implemented in the form of computer-executable instructions, logic, firmware, and/or hardware, that the functionality described with reference to it may not exist as separate identifiable block.

Referring to FIG. 9, in block 902 a system (such as server 104 (FIG. 1), application module 802 (FIG. 8), and other applications/code, etc. described above) records data indicative of a movement or behavior of a member with an online-business directory and/or social-network site.

In block 904, the system may associate the movement or behavior with a product or service category. For example, the user searched about pizza. So, the system may associate the activity about the broad category food, and the subcategories pizza, Italian food, and cholesterol-lowering drugs.

In block 906, the system determines whether the movement or behavior of a member (user) exceeds a specified threshold indicating a repetitive movement or interest within the online site. It is noted that in other embodiments, the behavior does not necessarily have to be repetitive.

In block 908, the system sends an advisement to member with content related to the associated product or service category, via a bulletin board, viewable by the member, when the movement or behavior is determined to exceed the specified threshold. Alternatively, in another embodiment, the system could also send an alert to an administrator (e.g. notify the administrator) of site 102, that a particular member is presently interested in particular topic, and the administrator may choose to use this information in a statistical nature for advertisers to bid.

Although various embodiments have been described above with reference to flowcharts and/or block diagrams, it is appreciated by those skilled in the art, after having the benefit of this disclosure that any blocks or functionality described therein may be implemented in code executed by a processor.

FIG. 10 illustrates an exemplary computing device 1002, which may be representative of server 104 or client-side computer 108. Generally, these devices may be any of a variety of computer devices, including desktop PCs, servers, mainframes, workstations, notebook or laptop computers, hand held or portable PCs, personal digital assistants (PDAs), cellular phones, Internet appliances, gaming consoles, portable communication devices, televisions/set-top boxes, wireless devices, multiprocessor systems, microprocessor systems, programmable consumer electronics, multimedia systems, a combination of any of the above example devices, and other smart devices.

Computing device 1002 includes at least one processor 1004 and memory 1006. Memory 1006 may include volatile memory (e.g., RAM) and/or non-volatile memory (e.g., ROM, PCMCIA cards, etc.). In some implementations, memory 1006 is used as part of a computer's cache, permitting application data to be accessed quickly without having to permanently store data in a non-volatile memory device.

Resident in the memory 1006 are one or more operating systems (not shown), and code 1008 that executes on processor 1004. For purposes of illustration, programs and other executable program modules are illustrated herein as discrete blocks, although it is recognized that such programs and components reside at various times in different storage components of device 1002, and are executed by the one or more processors.

Other elements such as power supplies, keyboards, touch pads, I/O interfaces, displays, LEDs, audio generators, vibrating devices, and so forth are not shown as being a part of device 1002, but could easily be a part of any such device. Additionally, although not shown, a system bus or point-to-point connections typically connects the various components within device 1002. It is noted that computer-executable instructions (code) may be located in both local and remote computer storage media, including memory storage devices (computer-readable media).

The embodiments described herein are to be considered in all respects only as exemplary and not restrictive. The scope of the invention is, therefore, indicated by the subjoined Claims rather by the foregoing description. All changes which come within the meaning and range of equivalency of the Claims are to be embraced within their scope.

What is claimed is:

1. A computer-implemented method for providing an online-business directory and/or social-network site, the method comprising:
displaying a plurality of business members on the online-business directory and/or social-network site; and
allowing each of the business members to list and sell, in real-time, their respective products or services directly to users on the online-business directory and/or social-network site.

2. The method as recited in claim 1, further comprising allowing each of the business members to customize a webpage on the online-business directory and/or social-network site, the webpage containing at least one section with products or services of a particular business member for direct sale to the user of the online-business directory and/or social-network site.

3. The method as recited in claim 1, further comprising associating a category with a group of products or services offered by the business members, and listing the group of products or services on a webpage according to the category associated therewith.

4. The method as recited in claim 1, further comprising transmitting data for displaying products or services according to a category associated with one of the products or services.

5. A computer system for providing an online-business directory and/or social-network site, the system comprising:
means for providing an online environment for displaying a plurality of business members on the online-business directory and/or social-network site; and
means for allowing each of the business members to list and sell, in real-time, their respective products or services, directly on the online-business directory and/or social-network site, and directly to users of the online-business director and/or social-network site.

6. The system as recited in claim 5, further comprising means for allowing each of the business members to customize a webpage on the online-business directory and/or social-network site, the webpage containing at least one section with products or services of a particular business member for direct, and instant sale to a user of the online-business directory and/or social-network site.

7. The system as recited in claim 5, further comprising means for associating a category with products or services offered by the business members, and listing the products or services on a webpage according to the category associated therewith.

8. The system as recited in claim 5, further comprising means for displaying products or services offered by the business members on the online-business directory or social-network site according to a category associated with one of the products or services.

9. One or more computer-readable media having computer-readable instructions thereon which, when executed by the one or more processors, cause a computer device to: provide an online environment for displaying a plurality of business members on the online-business directory and/or social-network site; and allowing each of the business members to list and sell, in real-time, their respective products or services, directly on the online-business directory and/or social-network site, and directly to users of the online-business directory and/or social-network site.

10. A computer-implemented method for advertising in an online-business directory and/or social-network site, the method comprising:
recording data indicative of a movement or behavior of a member within an online-business directory and/or social-network site;
associating the movement or behavior with a product or service category;
determining whether the movement or behavior of a member exceeds a specified threshold indicating a repetitive movement or behavior within the online-business directory and/or social-network site;
sending an advertisement to the member with content related to the associated product or service category, via a bulletin board, viewable by the member, when the movement or behavior of a member is determined to exceed the specified threshold.

11. The computer-implemented method as recited in claim 10, further comprising automatically notifying an advertiser of the member to transmit the advertisement.

12. The computer-implemented method as recited in claim 10, further comprising automatically notifying an advertiser of a target member to transmit the advertisement, and charging the advertiser a fee when the advertisement is transmitted.

13. The computer-implemented method as recited in claim 10, further comprising generating data for display on graphical user interface representing the bulletin board.

14. The computer-implemented method as recited in claim 10, wherein the bulletin board is only accessible by the member.

15. The computer-implemented method as recited in claim 10, further displaying a message on the bulletin board in a first predetermined color, and the advertisement in a second predetermined color different from the first predetermined color.

16. One or more computer-readable media having computer-readable instructions thereon which, when executed by the one or more processors, cause a computer device to:
record data indicative of a movement or behavior of a member within an online-business directory and/or social-network site;
associate the movement or behavior with a product or service category;
determine whether the movement or behavior of a member exceeds a specified threshold indicating a repetitive movement or behavior within the online-business directory and/or social-network site;
send an advertisement to the member with content related to the associated product or service category, via a bulletin board, viewable by the member, when the movement or behavior of a member is determined to exceed the specified threshold.
